(19) United States
(12) Patent Application Publication
(10) Pub. No.: US 2025/0002774 A1
(43) Pub. Date: Jan. 2, 2025

(54) APPLICATION OF THERMO-SENSITIVE HETEROPOLYSACCHARIDE POLYMER IN IMPROVEMENT OF OIL RECOVERY FACTOR

(71) Applicant: NANJING TECH UNIVERSITY, Nanjing, Jiangsu Province (CN)

(72) Inventors: Shuang LI, Nanjing, Jiangsu Province (CN); Haolin HUANG, Nanjing, Jiangsu Province (CN); Weiyi TAO, Nanjing, Jiangsu Province (CN); Dinghua YU, Nanjing, Jiangsu Province (CN); He HUANG, Nanjing, Jiangsu Province (CN)

(73) Assignee: NANJING TECH UNIVERSITY, Nanjing, Jiangsu Province (CN)

(21) Appl. No.: 18/707,608

(22) PCT Filed: Aug. 30, 2022
(86) PCT No.: PCT/CN2022/115666

§ 371 Date: May 6, 2024

(30) Foreign Application Priority Data
Nov. 10, 2021 (CN) 202111325182.6

(51) Int. Cl. C09K 8/588; C09K 8/42; C09K 8/44

(52) U.S. Cl. CPC C09K 8/588; C09K 8/426; C09K 8/44

(57) ABSTRACT

The invention discloses an application of a thermosensitive heteropolysaccharide polymer in enhancing oil recovery. The Sphingomonas sanxanigenens is Sphingomonas sanxanigenens HL-1. The thermosensitive heteropolysaccharide polymer is used for biopolymer flooding in medium and high temperature reservoirs under the condition of ≤70° C. in the form of fermentation broth or biopolymer solution; or is used for profile control and water plugging of high temperature reservoirs under the condition of ≥85° C. The thermosensitive heteropolysaccharide polymer provided in the present invention has a shear thinning property, is in a solid-like state, and features high viscosity, strong deformation resistance and thermally irreversible formation of solid gel at a high temperature and the degree of intermolecular entanglement is related to concentration. The thermosensitive heteropolysaccharide polymer possesses the excellent properties of xanthan gum and curdlan gum and has a wider scope of application in oil recovery.

### TECHNICAL FIELD

The present invention pertains to the technical field of biological engineering and specifically relates to the application of a thermosensitive heteropolysaccharide polymer in enhancing oil recovery.

### BACKGROUND ART

Sphingomonas were first proposed in 1990 by Japanese scholar Yabuuchi et al., based on the partial nucleotide sequence of 16S rRNA, the presence of unique glycosphingolipids and the major type of ubiquinone. Their main characteristics are as follows: Gram-negative, rod-shaped, acrobic, non-spore-forming, catalase-positive, and mostly able to produce a yellow pigment.

Some Sphingomonas can secrete acidic exopolysaccharides, which are collectively called sphingan and of which the main chain structure is relatively conserved, consisting of A(1→3)D-Glc(1→4)D-GlcA(1→4)D-Glc(1→)A, where A is L-Rha or L-Man in general. Although the composition of the main chain glycone of sphingans is not significantly different, the types and positions of side-chain glycones endow sphingans with structural and functional diversity, with unique physical, chemical, and rheological properties found in each sphingan. Enhanced oil recovery (EOR), also known as tertiary recovery, is of great value for improving the efficiency of oil extraction. With the deepening of oilfield development, most oil fields in China have been exploited, and it is difficult for the remaining harsh oil reservoirs, especially high temperature and salinity oil reservoirs to exploit by chemical polymers. The chemically hydrolyzed polyacrylamide (HPAM) is the most extensively used in EOR currently. However, HPAM can be degraded into toxic acrylamide monomers that can infiltrate into the groundwater, which will pollute the environment, cause aggregation in the human body and endanger life. Therefore, more environmentally friendly and efficient biopolymers should be sought to replace HPAM.

Typical sphingan includes welan gum, gellan gum, diutan gum, and etc. The application in EOR is a new development direction of sphingans in recent years. Biological gel is usually a pseudoplastic fluid, that is, the shearing rate is inversely proportional to the viscosity. For example, diutan gum, welan gum and the widely used xanthan gum have the characteristics of high temperature resistance and meanwhile can change the rheological properties of the aqueous solution. They can thicken liquid, suspend solid, stabilize emulsion or form a gel. Sphingans are not only non-toxic, harmless, safe and environmentally friendly, and can be used in extreme reservoir environments due to their unique physicochemical and rheological properties. Sphingans can become a good substitute for the chemical polymer HPAM commonly used in EOR.

### SUMMARY OF THE INVENTION

An objective of the present invention is to provide an application of a new thermosensitive heteropolysaccharide polymer produced by Sphingomonas sanxanigenens in EOR.

The thermosensitive heteropolysaccharide polymer is produced by Sphingomonas sanxanigenens HL-1 strain. The strain has been disclosed in the applicant's prior application CN113151050A, and the preservation number is CCTCC NO: M 2021162. The extracellular heteropolysaccharide polymer produced by this strain is significantly different from the known sphingans in terms of structural components. The research of the present invention shows that it has the typical rheological characteristics of sphingans such as shear-thinning and good viscoelastic properties. At the same time, it has significant thermosensitive characteristics, and can form a thermally irreversible high strength gel at high temperature such as curdlan gum, which can be used for biopolymer flooding in low and medium temperature reservoirs, and has the application potential of profile control and water plugging in high temperature reservoirs.

In order to achieve the foregoing technical objective, the present invention adopts the following technical solution:

An application of a thermosensitive heteropolysaccharide polymer in polymer flooding,
The thermosensitive heteropolysaccharide polymer is a heteropolysaccharide polymer produced by Sphingomonas sanxanigenens HL-1;
The thermosensitive heteropolysaccharide polymer is used for biopolymer flooding in medium and high temperature reservoirs under the condition of ≤70° C. in the form of fermentation broth or biopolymer solution;
The fermentation broth is an exopolysaccharide-containing fermentation broth generated from the fermentation of Sphingomonas sanxanigenens HL-1;
The biopolymer solution is a solution prepared by diluting the swollen pure exopolysaccharide extracted from the exopolysaccharide-containing fermentation broth.

As a preferred embodiment, the biopolymer solution is prepared by the following method: After the pure exopolysaccharide product is extracted from the exopolysaccharide-containing fermentation broth, the pure product is fully swollen at 50-70° C. and diluted with water to get a biopolymer solution. Swelling the pure exopolysaccharide product above 80° C. may lead to irreversible phase transition, affecting the properties of the fluid system, such as increased viscosity, poor fluidity and other problems, so the swelling temperature below 80° C. is used, usually at 50-70° C.

As a preferred embodiment, the mass concentration of the exopolysaccharide in the exopolysaccharide-containing fermentation broth is ≥2 g/L.

As a preferred embodiment, the thermosensitive heteropolysaccharide polymer is transported below the phase transition temperature, which refers to the phase transition temperature from a sol state to a gel state. When the temperature is lower than the phase transition temperature, the system has fluidity and is convenient for compounding and transportation.

Another objective of the present invention is to provide an application of a thermosensitive heteropolysaccharide polymer in reservoir plugging.

The thermosensitive heteropolysaccharide polymer is a heteropolysaccharide polymer produced by Sphingomonas sanxanigenens HL-1;

The thermosensitive heteropolysaccharide polymer is used for profile control and water plugging in high temperature reservoirs under the condition of ≥85° C. in the form of fermentation broth or biopolymer solution.

The fermentation broth is an exopolysaccharide-containing fermentation broth generated from the fermentation of Sphingomonas sanxanigenens HL-1;

The biopolymer solution is a solution prepared by diluting the swollen pure exopolysaccharide extracted from the exopolysaccharide-containing fermentation broth.

As a preferred embodiment, the biopolymer solution is prepared by the following method: After the pure exopolysaccharide product is extracted from the exopolysaccharide-containing fermentation broth, the pure product is fully swollen at 50-70° C. and diluted with water to get a biopolymer solution.

As a preferred embodiment, the fully swollen pure exopolysaccharide product is diluted with water to get a biopolymer solution with a mass concentration of ≥4 g/L.

As a preferred embodiment, the mass concentration of the exopolysaccharide in the exopolysaccharide-containing fermentation broth is ≥4 g/L.

As a preferred embodiment, the thermosensitive heteropolysaccharide polymer is transported below the phase transition temperature, which refers to the phase transition temperature from a sol state to a gel state.

As a preferred embodiment, the thermosensitive heteropolysaccharide polymer is used in alkaline high-temperature reservoir environments with salinity ≤50,000 mg/L.

The heteropolysaccharide polymer produced by Sphingomonas sanxanigenens in the present invention is thermosensitive. Below 70° C., its polysaccharide solution and fermentation broth have the viscoelasticity similar to that of xanthan gum and welan gum, and can be used for biopolymer flooding in medium and high temperature reservoirs. When the temperature is higher than 70° C., the phase is changed to form a solid gel with certain strength, similar to curdlan gum, which can be used for profile control and water plugging in high temperature reservoirs. The thermosensitive heteropolysaccharide polymer possesses the excellent properties of xanthan gum and curdlan gum and has a wider scope of application in oil recovery.

### BRIEF DESCRIPTION OF THE DRAWINGS

FIG. 1 is a structural diagram of sphingans synthesis by different Sphingomonas.

FIG. 2 is an infrared chromatogram of the exopolysaccharide produced by Sphingomonas sanxanigenens HL-1.

FIG. 3 is a concentration-viscosity diagram of the exopolysaccharide produced by Sphingomonas sanxanigenens HL-1.

FIG. 4 is a temperature-viscosity diagram of the exopolysaccharide produced by Sphingomonas sanxanigenens HL-1.

FIG. 5 is a pH-viscosity diagram of the exopolysaccharide produced by Sphingomonas sanxanigenens HL-1.

FIG. 6 is a shearing rate diagram of the exopolysaccharide produced by Sphingomonas sanxanigenens HL-1.

FIG. 7 is a frequency scan pattern of the exopolysaccharide produced by Sphingomonas sanxanigenens HL-1.

FIG. 8 is a stress scan diagram of the exopolysaccharide produced by Sphingomonas sanxanigenens HL-1.

FIG. 9 is a shearing rate pattern of different exopolysaccharides.

FIG. 10 is a frequency scan pattern of different exopolysaccharides.

FIG. 11 is a stress scan diagram of different exopolysaccharides.

FIG. 12 is a gel morphogram of different exopolysaccharides.

FIG. 13 shows the dynamic viscoelasticity measurement results of the HL-1 polysaccharide fermentation broth at different temperature.

FIG. 14 shows the gel state formed by the HL-1 polysaccharide fermentation broth at different temperature.

FIG. 15 shows the gel state formed by the HL-1 polysaccharide fermentation broth under different salinity.

FIG. 16 shows the gel state formed by the HL-1 polysaccharide fermentation broth under different salinity after addition of crude oil.

### DETAILED DESCRIPTION OF THE EMBODIMENTS

### Embodiment 1

This embodiment is used to describe a method for culturing an extracellular polymer produced by Sphingomonas sanxanigenens HL-1 (CCTCC NO: M 2021162). Embodiment 2 in the prior application CN113151050A can be referred to. The fermentation medium is optimized. The following steps are included:

(1) Take 200 μL of Sphingomonas sanxanigenens HL-1 bacterial solution from a strain preservation tube, put it into a triangular flask containing seed medium, culture it in a shaking table at 30° C. and 200 rpm for 24 h, take a small amount of bacterial solution by dipping an inoculation ring in the solution, draw lines on a strain activation plate, and culture it in an incubator at 30° C. for 48 h.

(2) Use an inoculation ring to pick one ring of a well-growing colony on the activation plate, inoculate it in a 250 mL triangular flask containing 50 mL seed medium and culture it in a shaking table at 30° C. and 200 rpm for 24 h.

(3) Inoculate the cultured seed solution into a 250 mL triangular flask containing 50 mL of fermentation medium at an inoculum size of 6% (v/v) and culture it in a shaking table at 30° C. and 200 rpm for 72 h.

Strain activation medium: 5 g of peptone, 3 g of beef extract, 5 g of NaCl, 15 g of agar, 1 L of water, sterilized at 121° C. for 20 min.

Seed medium: 20 g of sucrose, 1 g of yeast extract, 4 g of peptone, 2 g of K₂HPO₄, 0.1 g of MgSO₄, 1 L of water, pH 7.0-7.2, sterilized at 121° C. for 20 min.

Fermentation medium: 55 g of sucrose, 8 g of peptone, 2 g of NH₄Cl, 2 g of K₂HPO₄, 0.1 g of MgSO₄, 1 L of water, pH 7.0-7.2, sterilized at 121° C. for 20 min.

### Embodiment 2

This embodiment is used to describe a method for extracting the exopolysaccharide produced by Sphingomonas sanxanigenens HL-1. Embodiment 3 in the prior application CN113151050A can be referred to:

(1) Extraction of a crude exopolysaccharide product: Keep the fermentation broth in embodiment 1 in an 80° C. water bath for 20 min, dilute it with an equal volume of distilled water, centrifuge at 8000 r/min for 30 min to remove bacteria, collect the supernatant, concentrate it, add 95% ethanol in triple volume, mix well, put it in a refrigerator at 4° C. overnight, centrifuge at 8000 r/min for 30 min to remove the supernatant, repeat the above operations for multiple times, collect the precipitate, and dry it in the oven at 80° C. to constant weight to get a crude exopolysaccharide product.

(2) Removal of protein: Take an appropriate amount of the crude product, dissolve it in 100 mL of distilled water, heat and stir until dissolved, and add 20 mL of solution with chloroform:n-butanol at a ratio of 4:1, shake for 30 min, centrifuge at 8000 r/min for 30 min, collect the supernatant, and repeat the above operations for multiple times until no oily matter appears in the organic phase.

(3) Freeze drying: Put the crude product after removal of protein in a dialysis bag with molecular weight cutoff of 10,000 Da, concentrate it with polyethylene glycol, dialyze for 3 days, and freeze-drying the solution after dialysis to obtain a pure exopolysaccharide product. After the extraction of the polysaccharide from the Sphingomonas sanxanigenens HL-1 fermentation broth in embodiment 1, the yield of HL-1 exopolysaccharide is up to 30 g/L. Weigh 10 mg of the extracted pure HL-1 polysaccharide product, put it in an ampoule, add 10 mL of 3M TFA and hydrolyze it at 120° C. for 3 h. Accurately suck an acid hydrolysis solution, transfer it to a tube, blow it dry with nitrogen, add 5 mL of water, mix well by vortex, suck 100 μL, add 900 μL of deionized water, and centrifuge at 12,000 rpm for 5 min. Take the supernatant and conduct ion chromatography.

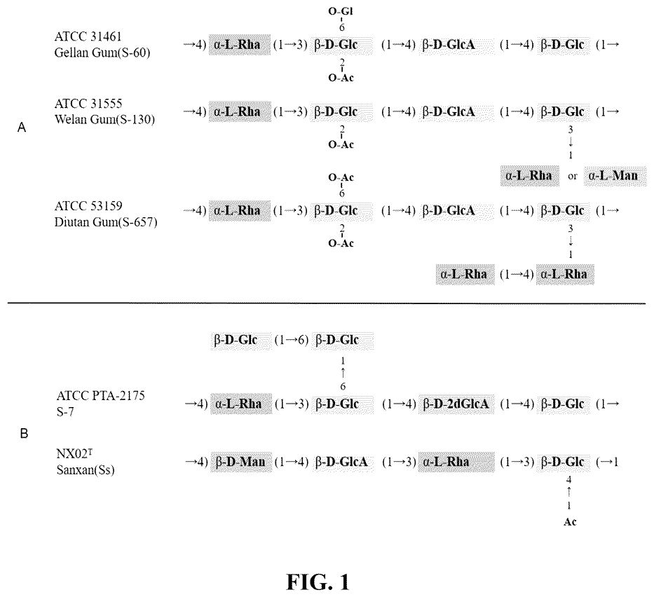

For the ion chromatogram of the hydrolysis system of the exopolysaccharides produced by Sphingomonas sanxanigenens HL-1, refer to FIG. 1 in the prior application CN113151050A. The main product peaks of HL-1 polysaccharide components are: arabinose (12.425 min), glucosamine hydrochloride (13.825 min), galactose (15.7 min), glucose (17.817 min), mannose (22.034 min), galacturonic acid (45.325 min) and guluronic acid (45.917 min), and the proportions of the above components are arabinose 0.2%, glucosamine 0.4%, galactose 0.2%, glucose 89.3%, mannose 1.9%, galacturonic acid 5.5% and guluronic acid 2.5%, respectively.

At present, the exopolysaccharides that can be mass synthesized by Sphingomonas sp. as reported typically include welan gum, gellan gum, diutan gum and sanxan gum. Their main monosaccharide components and structures are shown in FIG. 1. The polysaccharide components produced by Sphingomonas sanxanigenens HL-1 are significantly different from welan gum (composed of D-glucose, D-glucuronic acid, L-mannose and L-rhamnose), gellan gum (composed of D-glucose, D-glucuronic acid and L-rhamnose) and diutan gum (composed of D-glucose, D-glucuronic acid and L-rhamnose) in terms of components and are also significantly different from sanxan gum produced by the same strain Sphingomonas sanxanigenens NX-02 in components.

### Embodiment 3

This embodiment is used to describe the infrared spectrum identification results of the exopolysaccharide produced by Sphingomonas sanxanigenens HL-1.

Take a small amount of the pure HL-1 polysaccharide product extracted in embodiment 2, mix it with an appropriate amount of dry KBr, grind them evenly under an infrared lamp, press them into a transparent sheet by a mold, and scan with an FT-IR instrument in the range of 4,000˜400 cm⁻¹.

FIG. 2 is an infrared chromatogram of the exopolysaccharide produced by Sphingomonas sanxanigenens HL-1. The absorption peak at 3675.36 cm⁻¹ is the characteristic peak of free O—H, the absorption peak at 3521.64 cm⁻¹ shows the stretching vibration of polysaccharide O—H, which is the characteristic absorption peak of polysaccharides and is related to intramolecular hydrogen bond, the absorption peak at 2885.78 cm⁻¹ shows the stretching vibration of glycidyl C—H, which further proves that this substance is polysaccharides, the absorption peaks at 1723.83 cm⁻¹ and 1645.81 cm⁻¹ show the stretching vibration of COO group and indicate that the substance is acidic polysaccharides containing a certain amount of acidic groups, the absorption peaks at 1558.20 cm⁻¹, 1451.95 cm⁻¹ and 1380.35 cm⁻¹ were caused by C—H or O—H bending vibration, while 1251.26 cm⁻¹ was caused by O—H deformation vibration. The bands between 1101.86 cm⁻¹, 1081.41 cm⁻¹ and 1031.63 cm⁻¹ were characteristic absorption peaks of pyranose ring C—O—C. In addition, the band at 979.94 cm⁻¹ indicates the presence of β-type glycosidic linkage in HL-1.

### Embodiment 4

This embodiment is used to describe the biochemical analysis results of the exopolysaccharide produced by Sphingomonas sanxanigenens HL-1.

Take a small amount of the pure HL-1 polysaccharide product extracted in embodiment 2 to analyze the basic structure and calculate the content of components by drawing a corresponding standard curve.

The content of total sugar in the polysaccharide sample determined by the H₂SO₄-phenol method is 69.64%, the content of uronic acid in the polysaccharide sample determined by the H₂SO₄-carbazol method is 14.24%, the content of protein in the polysaccharide sample determined by the Bradford method is 4.6%, the content of O-acetyl group in the polysaccharide sample determined in reference to the Chinese Regulation on Biological Products is 16%, and the main types of glycosidic linkage determined by the Periodate-oxidation method are 1→2, 1→4 and 1→6. There are some differences between the types of main glucosidic linkage of the HL-1 polysaccharide and the glucosidic linkage on the main chain of sphingans, indicating that the HL-1 polysaccharide is a new type of sphingan. At present, curdlan gum is a common thermosensitive gel. Its main chain structure is a glucose monomer coupled with β-(1→3) glucosidic bond, and schizophyllan and micronucleus polysaccharides are similar in structure. Obviously, the type and components of the glucosidic bond of the polysaccharides produced by Sphingomonas sanxanigenens HL-1 are significantly different from them. Therefore, the polysaccharide produced by Sphingomonas sanxanigenens HL-1 is a kind of thermosensitive polysaccharide with a new structure.

### Embodiment 5

This embodiment is used to describe the effect of concentration, temperature, pH and other environmental factors on the viscosity of the exopolysaccharide produced by Sphingomonas sanxanigenens HL-1.

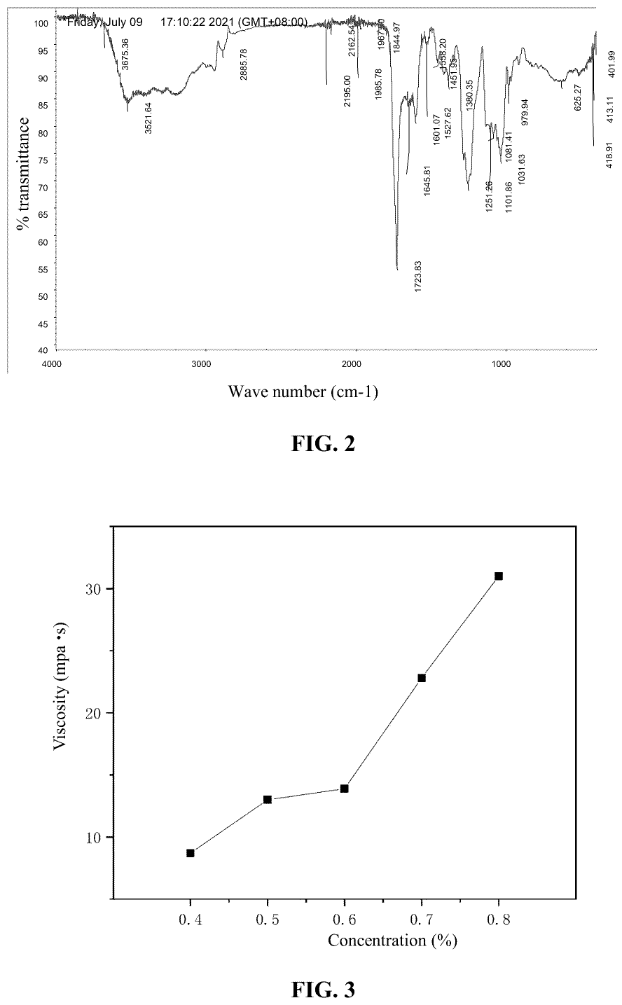

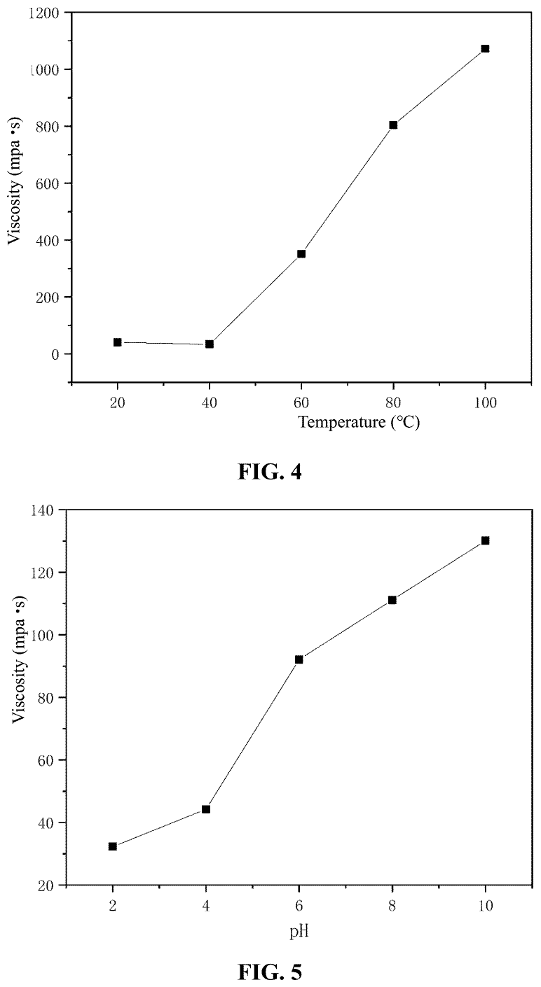

(1) Effect of concentration on the viscosity of the polymer: Make the HL-1 polysaccharide fermentation broth (polysaccharide concentration 3%, w/v) in embodiment 1 into biopolymer solutions with mass concentrations of 0.4%, 0.5%, 0.6%, 0.7% and 0.8%, respectively, and determine the solution viscosity by an IKA rotary viscometer (rotor type: VOL-SP-6.7, rotation speed 30 rpm) at room temperature. As shown in FIG. 3, the viscosity of the biopolymer solution increases with the increase of the concentration, and shows a linear increase when the concentration is more than 0.6%.

(2) Effect of temperature on the viscosity of the polymer: Make the HL-1 polysaccharide fermentation broth in embodiment 1 (polysaccharide concentration 3%, w/v) into a biopolymer solution with a mass concentration of 1%, and determine the viscosity of the biopolymer solution by an IKA rotary viscometer (rotor type: VOL-SP-6.7, rotation speed 30 rpm) at 20° C., 40° C., 60° C., 80° C. and 100° C., respectively. As shown in FIG. 4, the viscosity of the biopolymer solution increases with the increase of the temperature, particularly above 60° C. and shows that this biopolymer has good temperature resistance and is suitable for medium and high temperature reservoirs.

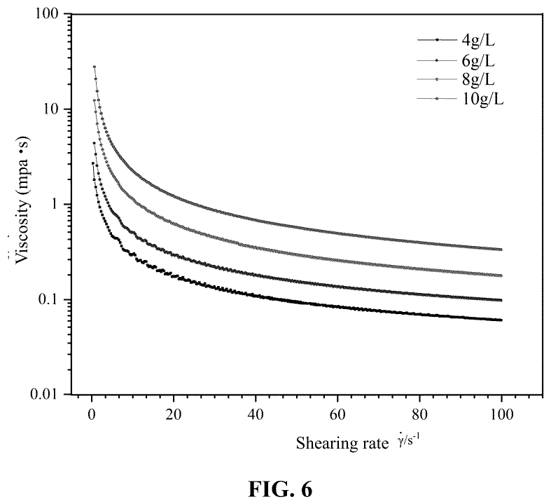

(3) Effect of pH on the viscosity of the polymer: Make the HL-1 polysaccharide fermentation broth in embodiment 1 (polysaccharide concentration 3%, w/v) into a biopolymer solution with a mass concentration of 1%, use HCl or NaOH to adjust the pH of the solution, and determine the viscosity of the biopolymer solution by an IKA rotary viscometer (rotor type: VOL-SP-6.7, rotation speed 30 rpm) at room temperature when pH=2, 4, 6, 8, 10. As shown in FIG. 5, the viscosity of the biopolymer solution is low when pH is 2, but the viscosity increase with the gradual increase of pH, indicating that the biopolymer has strong alkali resistance and is more suitable for an alkaline reservoir environments.

### Embodiment 6

This embodiment is used to describe the performance evaluation of the exopolysaccharide produced by Sphingomonas sanxanigenens HL-1.

(1) Preparation of biopolymer solutions: Weigh a certain mass of biopolymer powder (the pure freeze-drying exopolysaccharide product in embodiment 2), dissolve it in an appropriate amount of water, place it in a 50° C. water bath for 24 h for complete swelling, and prepare biopolymer solutions with mass concentrations of 0.2%, 0.4%, 0.6%, 0.8% and 1.0%, respectively.

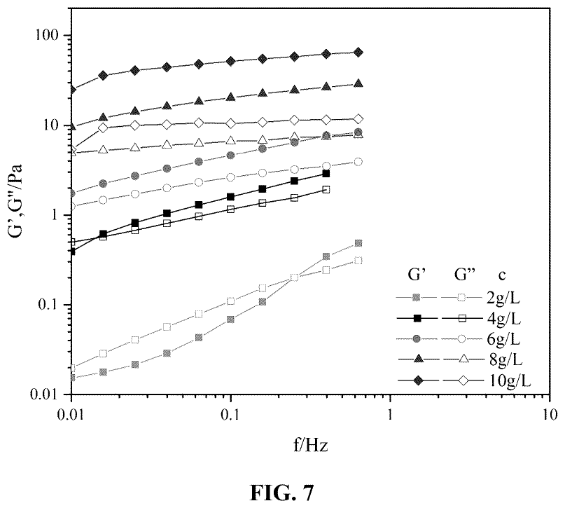

(2) Effect of shearing rate on the viscosity of the polymer: At room temperature, determine the viscosity of the biopolymer solutions with mass concentrations of 0.4%, 0.6%, 0.8% and 1.0%, respectively at different shearing rates by a rheometer. The results are shown in FIG. 6, the viscosity of the biopolymer solution increases with the increase of concentration, and it was also found that the viscosity of the biopolymer solution drops sharply and tends to be gentle with the continuous increase of the shearing rate, showing a typical pseudoplastic fluid characteristic, which means the apparent viscosity of the fluid decreases with the increase of the shearing rate, that is, the shear thinning phenomenon.

(3) Effect of frequency on polymer state: At room temperature, determine the modulus of the biopolymer solutions with mass concentrations of 0.2%, 0.4%, 0.6%, 0.8% and 1.0%, respectively under different frequencies by a rheometer. As shown in FIG. 7, the biopolymer can undergo phase transition at a low concentration (4 g/L), from a sol state to a gel state, that is, from the fluid-like to the solid-like, and the intersection point is the gel point. When the concentration is greater than 4 g/L, with the continuous increase of the concentration, the storage modulus and loss modulus also increase, and the storage modulus is always greater than the loss modulus, and the state is solid-like. This result shows that the operating concentration of the biopolymer can be as low as 0.4% when used in reservoir plugging, showing significant potential applicability.

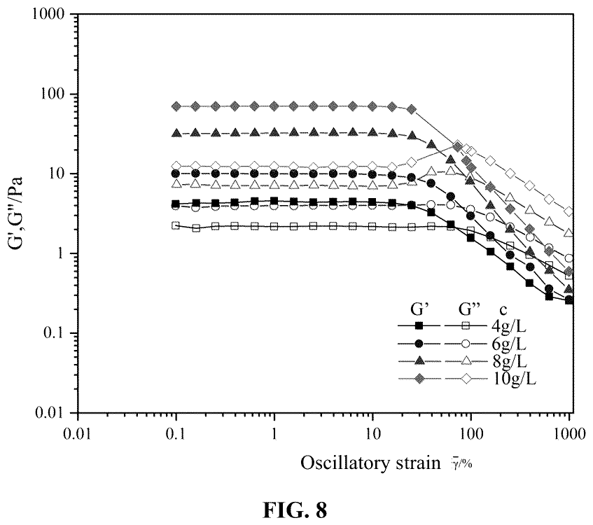

(4) Effect of stress change on polymer state: At room temperature, determine the modulus of the biopolymer solutions with mass concentrations of 0.4%, 0.6%, 0.8% and 1.0%, respectively under different stresses by a rheometer. The results are shown in FIG. 8, the storage modulus of the biopolymer is greater than the loss modulus at any concentration, and there was an intersection point, indicating that phase transition occurred, from the gel state to the sol state. At the same time, with the increase of the concentration, the intersection point changed slightly to the left, indicating that the degree of intermolecular entanglement changes.

### Embodiment 7

This embodiment is used to compare the property differences between the polymer produced by Sphingomonas sanxanigenens HL-1 and other biopolymers.

(1) Preparation of biopolymer solution: Weigh a certain mass of the biopolymer powder, dissolve it in an appropriate amount of water, place it in a 60° C. water bath for complete swelling, and prepare a biopolymer solution with a mass concentration of 1.0%.

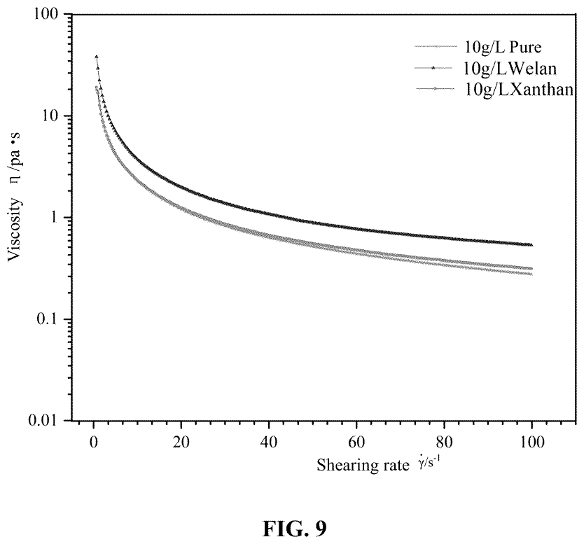

(2) Effect of shearing rate on the viscosity of the polymer: At room temperature, determine the viscosity of the HL-1 biopolymer, xanthan gum and welan gum with a mass concentration of 1.0% by a rheometer under different shearing rates. The results are shown in FIG. 9, at the same concentration, welan gum has higher viscosity, and xanthan gum and HL-1 polymer have little difference in viscosity, indicating that this biopolymer and xanthan gum have the same good shear thinning property.

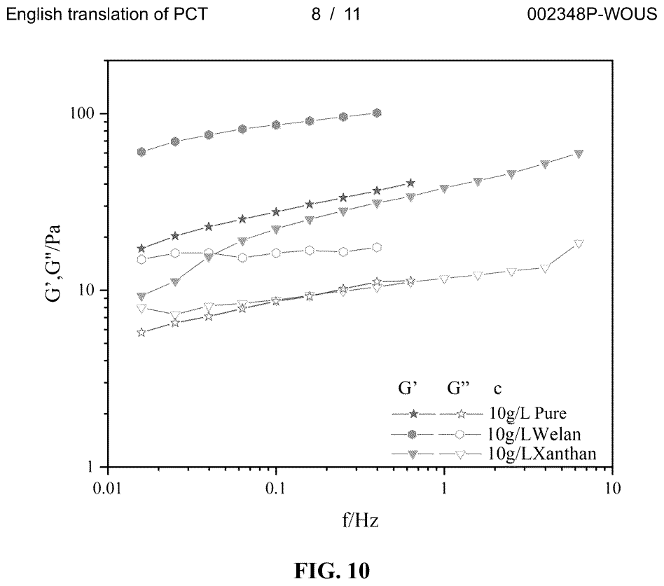

(3) Effect of frequency change on polymer state: At room temperature, determine the modulus of the HL-1 biopolymer, xanthan gum and welan gum with a mass concentration of 1.0% by a rheometer under different frequencies. The results are shown in FIG. 10, at the same concentration, the three polymers are all in a solid-like state, the storage modulus of welan gum is greater than that of the HL-1 biopolymer, and that of the HL-1 biopolymer is greater than that of xanthan gum, indicating that welan gum has the highest stiffness and the strongest deformation resistance, followed by the HL-1 biopolymer and xanthan gum. In addition, the loss modulus of welan gum is greater than that of the HL-1 biopolymer, and the loss modulus of the HL-1 biopolymer is close to that of xanthan gum, indicating that welan gum has the highest viscosity, and the viscosity of the HL-1 biopolymer is close to that of xanthan gum and smaller than that of welan gum.

(4) Effect of stress change on polymer state: At room temperature, determine the modulus of this biopolymer, xanthan gum and welan gum with a mass concentration of 1.0% by a rheometer under different stresses. The results are shown in FIG. 11, at the same concentration, the intersection point between storage modulus and loss modulus of welan gum is leftmost, that of xanthan gum is in the middle, and that HL-1 biopolymer is rightmost, indicating that welan gum has the largest molecular weight, xanthan gum has a medium molecular weight, and HL-1 biopolymer has the smallest molecular weight.

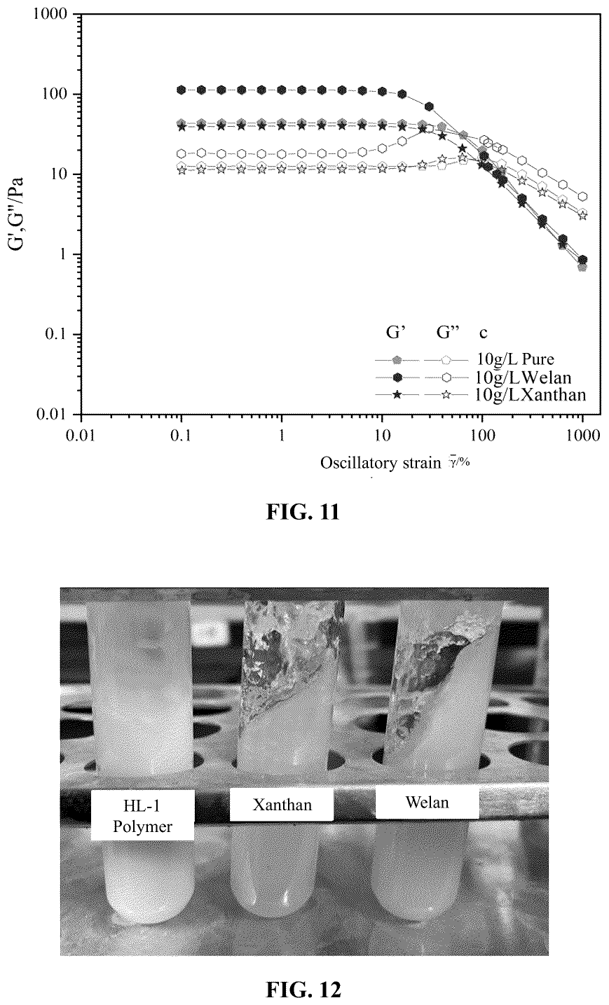

(5) Effect of temperature on polymer state: Do a gel test according to the national standard GB 28304-2012, heat the biopolymer solution with a mass concentration of 1.0% in a 100° C. water bath for 20 min, cool it to room temperature and observe the morphologic changes of the biopolymer. The results are shown in FIG. 12, at the same concentration, the HL-1 biopolymer can form a solid gel with certain strength after heating, but the gels formed by xanthan gum and welan gum have very weak strength and poor deformation resistance.

By comparing the properties, it can be found that the exopolysaccharide produced by Sphingomonas sanxanigenens HL-1 possesses the rheological characteristics of sphingans, which means the shear thinning property, as well as good deformation resistance and viscoelasticity, indicating that the HL-1 polysaccharide has potential applications similar to those of welan gum and xanthan gum. The HL-1 polysaccharide can form a solid gel with certain strength at a high temperature, which makes the HL-1 polysaccharide have a potential application range similar to that of curdlan gum.

### Embodiment 8

This embodiment is used to describe the thermosensitive characteristics of the fermentation broth of the exopolysaccharide produced by Sphingomonas sanxanigenens HL-1.

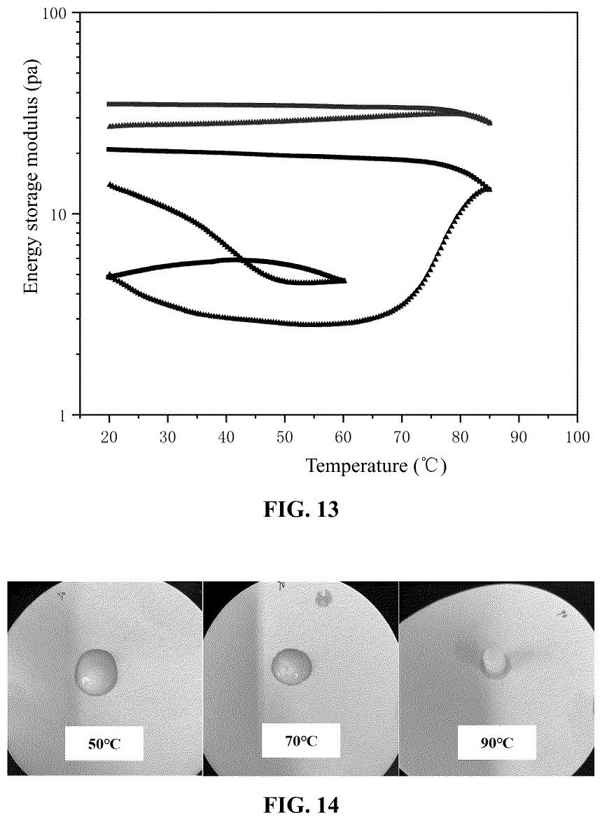

Measure the dynamic viscoelasticity of the HL-1 polysaccharide fermentation broth in Embodiment 1 by a rheometer, and determine the modulus of the gel system at different temperatures through three temperature cycles (20° C.-60° C.-20° C.-85° C.-20° C.-85° C.) to observe the gel properties of the HL-1 fermentation broth. The results are shown in FIG. 13, the dynamic viscoelasticity of the HL-1 polysaccharide fermentation broth at different temperatures is similar to that of curdlan gum (Cai Z, Zhang H. Recent progress on curdlan gum provided by functionalization strategies [J]. Food Hydrocolloids, 2017, 68:128-135). There are two sol-gel transitions and one gel-gel transition in the whole thermal cycle. When the HL-1 fermentation broth is heated to 40-60° C., a sol with good fluidity can be formed and when it is cooled to 20° C. to form a low-strength gel (the first type of gel), which is thermodynamically reversible or partially reversible. On this basis, the fermentation broth is heated to 85° C., and begins to enter a rapid gelling state after the temperature exceeds 70° C., and the gel (the second type of gel) is thermodynamically irreversible. On this basis, the gel strength of the third type of gel formed by cooling the second type of gel will be higher, and this transition is also thermodynamically irreversible. The above experimental results show that temperature is a key factor of the HL-1 polysaccharide gel. The HL-1 polysaccharide obtained in the present invention show complex temperature dependence. The temperature-sensitive rheological property of the HL-1 polysaccharide makes the HL-1 fermentation broth have good fluidity in the preparation and transport processes for oil recovery.

### Embodiment 9

This embodiment is used to describe the effects of temperature, salinity, crude oil and other environmental factors on gelling and gel strength of the exopolysaccharide produced by Sphingomonas sanxanigenens HL-1.

(1) Effect of different temperature on polymer gelling: Heat the HL-1 polysaccharide fermentation broth in embodiment 1 (polysaccharide concentration 3%, w/v) in a 50° C., 70° C., 90° C. water bath for 20 min, cool it to room temperature, and observe the state change of the HL-1 polysaccharide fermentation broth. The results are shown in FIG. 14, at the same concentration, the HL-1 polysaccharide fermentation broth is still in the sol state at 50° C. and 70° C., and can form a gel at 90° C., indicating that the HL-1 polysaccharide fermentation broth can form a gel at a high temperature.

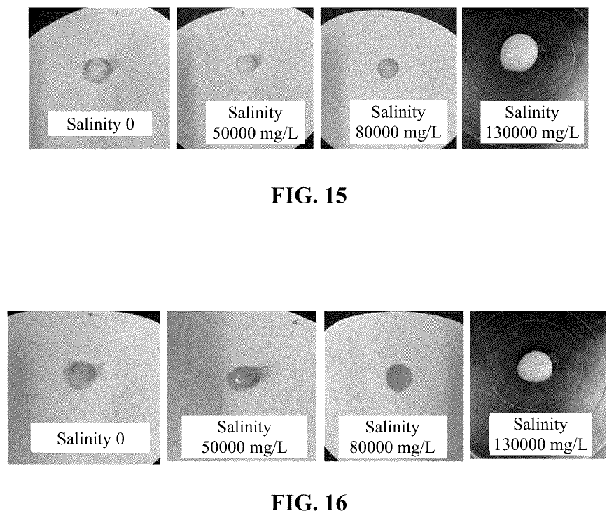

(2) Effect of different salinity on polymer gelling: Considering the pH of the actual reservoir, make the HL-1 polysaccharide fermentation broth in embodiment 1 (polysaccharide concentration 3%, w/v) into a biopolymer solution with a mass concentration of 1%, adjust the pH to 8, adjust the salinity of the polysaccharide solution to 0, 50,000, 80,000 and 130,000 mg/L respectively, heat them in a 90° C. water bath for 20 min, cool them to room temperature and observe the state changes of the biopolymer. The results are shown in FIG. 15. At the same temperature, when the salinity reaches 80,000 mg/L, the polymer solution cannot form a gel, but when the salinity reaches 50,000 mg/L, the polymer solution has good gelling performance, indicating that the HL-1 biopolymer is suitable for plugging operations of high temperature reservoirs with salinity less than 50,000 mg/L.

(3) Effect of crude oil on polymer gelling: Make the HL-1 polysaccharide fermentation broth in embodiment 1 (polysaccharide concentration 3%, w/v) into a biopolymer solution with a mass concentration of 1%, adjust pH to 8, add crude oil with a final concentration of 1,000 ppm, and adjust salinity to 0, 50,000, 80,000, 130,000 mg/L, heat them in a 90° C. water bath for 20 min, cool it to room temperature, and observe the state changes of the biopolymer. The results are shown in FIG. 16. At the same temperature, the addition of crude oil has no effect on gelling, indicating that this biopolymer has a good practical application prospect.

(4) Determination of gel strength: Determine the gel strength of the gel formed in this embodiment, stir the prepared biopolymer solution by a cylindrical emulsifier dispersing machine at 3,500 r/min for 5 min, put the suspension in a mold with a diameter of 9.5 mm, aerate it under vacuum for 3 min, quickly put it in a 90° C. water bath, heat it for 20 min, cool it to room temperature, remove the gel from the mold, measure its height and do a compression test of the gel formed by this biopolymer at 90° C. using a universal testing machine to calculate the gel strength.

The formula for calculating gel strength involved in the experiment is as follows, and the value is expressed in grams per square centimeter (g/cm²):

Gel strength (W)=F/g/πr²

Where, F is the reading of the inflection point at which the curve drops sharply when the gel is broken on the load-time (F-T) curve, and the unit is N. g is the acceleration of gravity, and the unit is meters per square second (m/s²). r is the radius of the mold, and the unit is millimeter (mm).

The results are shown in Table 1:

TABLE 1
Determination of Gel Strength of Various Gel Samples

| Sample description | Sample 1 | Sample 2 | Sample 3 | | Sample 4 | | Sample 5 | | Sample 6 | |
|---|---|---|---|---|---|---|---|---|---|---|
| Polysaccharide | 3% | 1% | 1% | | 1% | | 1% | | 1% | |
| concentration | | | | | | | | | | |
| pH | pH 7 | pH 8 | pH 8 | | pH 8 | | pH 8 | | pH 9 | |
| Salinity | 0 | 0 | 50000 | mg/L | 0 | | 50000 | mg/L | 50000 | mg/L |
| Crude oil | 0 | 0 | 0 | | 1000 | ppm | 1000 | ppm | 1000 | ppm |
| Gel strength | 3144.30 g/cm² | 2941.68 g/cm² | 67.82 | g/cm² | 344.53 | g/cm² | 2932.60 | g/cm² | 3064.23 | g/cm² |

The results of Table 1 indicate that the gel formed by the HL-1 polysaccharide fermentation broth at a high temperature (90° C.) has relatively high gel strength and good toughness. As a single factor, crude oil and salinity will greatly reduce the gel strength, but in an alkaline environment of pH 8-9, 1,000 ppm crude oil and 50,000 mg/L salinity can help the HL-1 polymer to bind with free water and improve the gelling toughness, and the gel strength can be restored to the blank control state, reaching about 3,000 g/cm². The results show that the HL-1 biopolymer can form a high strength gel in real high temperature oil reservoirs, is suitable for use as a plugging agent and has a good application prospect.

### Embodiment 10

This embodiment is used to describe a simulated core flooding effect of the exopolysaccharide fermentation broth produced by Sphingomonas sanxanigenens HL-1.

Obtain the exopolysaccharide fermentation broth produced by Sphingomonas sanxanigenens HL-1 as described in embodiment 1, take a certain amount of the HL-1 polysaccharide fermentation broth, and use tape water to dilute it till the concentration of the HL-1 polysaccharide is 0.2% (w/v). Select a multi-function steam and foam displacement experimental device (ZQPM-II) and an artificial loose core with a diameter of 3.80 cm, length of 60.00 cm and porosity of 41.26%. Core conditions: saturated oil volume 275 mL; temperature: 60° C.; polymer flooding injection rate: 240 mL/h; displacement fluid injection rate: 240 mL/h. Method: 1) Blank group: after oil saturation of the model, age it at 40° C. for 12 h, and inject distilled water in the forward direction at 60° C. for 10 PV displacement. 2) Experimental group: After oil saturation of the model, age it at 40° C. for 12 h, inject distilled water in the forward direction at 60° C. for 6 PV displacement and turn to HL-1 biopolymer for 4 PV displacement.

Evaluation results: In the process of oil displacement, the volume of oil displacement does not increase after 6 PV water injection. At the moment, the HL-1 biopolymer is injected for displacement. After injection of 0.5 PV HL-1 biopolymer, a large amount of crude oil is driven out, and the improvement of oil displacement efficiency is mainly concentrated within 0.5-1.0 PV. The displacement volume of water flooding is 212 mL, and the displacement efficiency is 72.3%. The displacement volume of HL-1 biopolymer is 238 mL, and the displacement efficiency is 79.4%. The displacement efficiency increases by 7.1%.

What is claimed is:

1. An application of a thermosensitive heteropolysaccharide polymer in enhancing oil recovery, wherein:
the thermosensitive heteropolysaccharide polymer is a heteropolysaccharide polymer produced by Sphingomonas sanxanigenens HL-1;
the thermosensitive heteropolysaccharide polymer being used for biopolymer flooding in medium and high temperature reservoirs under the condition of ≤70° C. in the form of fermentation broth or biopolymer solution;
the fermentation broth being an exopolysaccharide-containing fermentation broth generated from fermentation of Sphingomonas sanxanigenens HL-1; and
the biopolymer solution is a solution prepared by diluting the swollen pure exopolysaccharide extracted from the exopolysaccharide-containing fermentation broth.

2. The application according to claim 1, wherein the biopolymer solution is prepared by: After the extraction of a pure exopolysaccharide product from the exopolysaccharide-containing fermentation broth, fully swelling the pure exopolysaccharide product under the condition of 50-70° C. and adding water to dilute it to get a biopolymer solution.

3. The application according to claim 1, wherein the mass concentration of the exopolysaccharide in the exopolysaccharide-containing fermentation broth is ≥2 g/L.

4. The application according to claim 1, wherein the thermosensitive heteropolysaccharide polymer is transported below the phase transition temperature, which refers to the phase transition temperature from a sol state to a gel state.

5. An application of a thermosensitive heteropolysaccharide polymer in reservoir plugging, wherein:
the thermosensitive heteropolysaccharide polymer is a heteropolysaccharide polymer produced by Sphingomonas sanxanigenens HL-1;
the thermosensitive heteropolysaccharide polymer, in the form of fermentation broth or biopolymer solution, being used for profile control and water plugging of high temperature reservoirs under the condition of ≥85° C.;
the fermentation broth being an exopolysaccharide-containing fermentation broth generated from fermentation of Sphingomonas sanxanigenens HL-1; and
the biopolymer solution is a solution prepared by diluting the swelling pure exopolysaccharide extracted from the exopolysaccharide-containing fermentation broth.

6. The application according to claim 5, wherein the biopolymer solution is prepared by: After the extraction of a pure exopolysaccharide product from the exopolysaccharide-containing fermentation broth, fully swelling the pure exopolysaccharide product under the condition of 50-70° C. and adding water to dilute it to get a biopolymer solution.

7. The application according to claim 5, wherein the fully swollen pure exopolysaccharide product is diluted with water to get a biopolymer solution with a mass concentration of ≥4 g/L.

8. The application according to claim 5, wherein the mass concentration of the exopolysaccharide in the exopolysaccharide-containing fermentation broth is ≥4 g/L.

9. The application according to claim 5, wherein the thermosensitive heteropolysaccharide polymer is transported below the phase transition temperature, which refers to the phase transition temperature from a sol state to a gel state.

10. The application according to claim 5, wherein the thermosensitive heteropolysaccharide polymer is used in alkaline high-temperature reservoir environments with salinity ≤50,000 mg/L.
